(19) United States
(12) Patent Application Publication
(10) Pub. No.: US 2011/0223319 A1
(43) Pub. Date: Sep. 15, 2011

(54) METHOD OF FABRICATING ELECTROLUMINESCENCE DISPLAY

(75) Inventors: Tomohito KAWASHIMA, Kanagawa-ken (JP); Junichi Tonotani, Kanagawa-ken (JP)

(73) Assignee: Kabushiki Kaisha Toshiba, Tokyo (JP)

(21) Appl. No.: 13/040,897

(22) Filed: Mar. 4, 2011

(30) Foreign Application Priority Data
Mar. 11, 2010 (JP) 2010-055102

(51) Int. Cl. B05D 5/12; B05D 5/06

(52) U.S. Cl. 427/66

(57) ABSTRACT

An aspect of the present disclosure, there is provided a method of fabricating an organic electroluminescence display device, including forming a plurality of first electrodes with a prescribed interval on a substrate, forming a light emission function layer including a light emission layer on at least an upper surface of each of the first electrodes, forming a barrier layer on a upper surface of the light emission function layer between the first electrodes after forming the light emission function layer, forming a second electrode on the first electrode.

### CROSS REFERENCE TO RELATED APPLICATION

This application is based upon and claims the benefit of priority from prior Japanese Patent Application No. 2010-055102, filed on Mar. 11, 2010, the entire contents of which are incorporated herein by reference.

### FIELD

Exemplary embodiments described herein generally relate to a method of fabricating an organic electroluminescence display device used as a display.

### BACKGROUND

Generally, an organic electroluminescence (called an organic EL hereinafter) display device used as a display includes a laminated layer with a light emission function layer, a second electrode (cathode) and the like on a substrate. The light emission function layer includes thin film transistors, first electrodes (pixel electrode or anode), hole injection layers, and organic EL elements. Further, the laminated layer is encapsulated by resin, for example.

First, as shown in FIG. 8A, the thin film transistors, the wirings or the like are formed on a main substrate body in conventional technology. Subsequently, the main substrate is covered with an interlayer insulator to form a substrate 101.

Next, pixel electrodes 102 are arranged with prescribed interval on the interlayer insulator of the substrate 101, and each of the pixel electrodes 102 is electrically connected to each of thin film transistors.

Next, as shown in FIG. 8B, each of barrier layers 103 is formed between the pixel electrodes 102 in order to separate each of the pixel regions.

After that, as shown in FIG. 8C, a hole injection layer 104 and a light emission function layer 105 are laminated in an order on the pixel electrode 102 between the barrier layers 103. Next, a cathode 106 is formed on the light emission function layer 105 including the barrier layer 103 to form a device structure. Subsequently, the device structure is encapsulated by an encapsulating substrate. However, the light emission function layer 104 is formed after forming the barrier layer 103 by thermal printing in a method of fabricating the organic EL display device in conventional technology.

Therefore, a shape of the barrier layer 103 is deformed by heat which is generated in printing an image of the light emission function layer 105. Consequently, failure such as variability of a transfer width or a transfer defect is easily generated. In the printing process, the transfer defect is generated when a transfer material is printed from a portion above the barrier layers so as to trap air bubbles between the barrier layers. Accordingly, improvement of transfer accuracy is further desired.

### BRIEF DESCRIPTION OF THE DRAWINGS

FIG. 1A and FIG. 1B are a cross-sectional view taken along A-A line in FIG. 1B and a plane view showing an organic EL display device according to an embodiment;

FIG. 2 is a cross-sectional view showing a method of fabricating the organic EL display device according to the embodiment;

FIG. 3 is a cross-sectional view showing the method of fabricating the organic EL display device according to the embodiment;

FIG. 4 is a cross-sectional view showing the method of fabricating the organic EL display device according to the embodiment;

FIG. 5 is a cross-sectional view showing the method of fabricating the organic EL display device according to the embodiment;

FIG. 6 is a cross-sectional view showing the method of fabricating the organic EL display device according to the embodiment;

FIGS. 7A, 7B, 7C are cross-sectional views showing a method of fabricating an organic EL display device according to a modification of the embodiment;

FIGS. 8A, 8B, 8C are cross-sectional views showing a method of fabricating an organic EL display device as a conventional case.

### DETAILED DESCRIPTION

An aspect of the present disclosure, there is provided a method of fabricating an organic electroluminescence display device, including forming a plurality of first electrodes with a prescribed interval on a substrate, forming a light emission function layer including a light emission layer on at least an upper surface of each of the first electrodes, forming a barrier layer on a upper surface of the light emission function layer between the first electrodes after forming the light emission function layer, forming a second electrode on the first electrode.

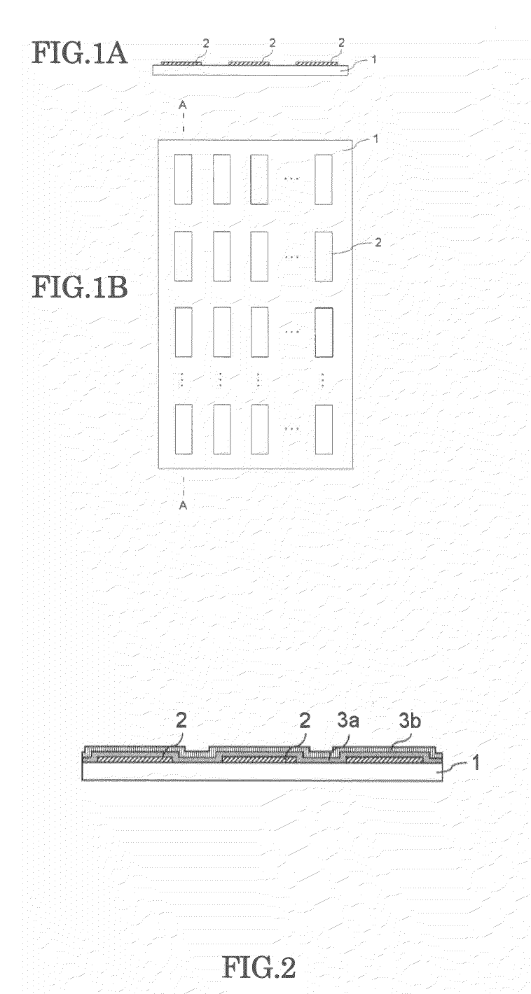

Embodiments of a method of fabricating an organic EL display device will be described below in detail with reference to FIGS. 1-6 mentioned above.

Throughout the attached drawings, similar or same reference numerals show similar, equivalent or same components.

A fabricating method according to the embodiments includes forming a substrate, forming an encapsulating substrate, and sticking both the substrate and the encapsulating substrate each other.

First, forming the substrate is described with reference to FIG. 1. As shown in FIG. 1A, first electrodes 2 called a pixel electrode or an anode are formed on a substrate 1.

Thin film transistors, each of which is called as TFT hereinafter, as a switching transistor, wirings and the like are formed on a substrate body of the substrate 1. An interlayer insulator is arranged on the substrate to cover the thin film transistors and the wirings. Further, a contact plug is formed in a surface of the planarized interlayer insulator in order to connect between the first electrode 2 and the TFT.

a substrate body is formed by a transparent material or an opaque material. A glass substrate, a transparent resin substrate or the like, for example, is used as the transparent substrate, and a metal substrate, an opaque resin substrate or the like, for example, is used as the opaque material.

In forming TFT or various kinds of wirings, after various kinds of films are formed by CVD, sputtering or the like, which are well-known methods, the films are patterned by photolithography and etching or the like, which are well-known methods. Further, a source area and a drain area of the TFT are formed by ion-doping or the like, which are well-known method.

As shown in FIG. 1B, the first electrodes 2 are arranged with a prescribed interval insulator on the interlayer of the substrate 1 as a matrix. Each of the first electrode 2 is constituted with a single layer structure composed of photo-reflective metal such as aluminum (Al) or the like, for example, or a stacked structure composed of a photo-reflective metal and a transparent conductive film such as indium-tin oxide (ITO) or the like, for example. The first electrode 2 is formed by well-known vacuum evaporation using a mask.

As shown in FIG. 2, the hole injection layer 3a is formed on the interlayer insulator so as to cover the first electrodes 2, subsequently, and hole transport layer 3b is laminated on the injection layer 3a. The hole injection layer 3a and the hole transport layer 3b are formed as a laminated layer by well-known vacuum evaporation.

Further, the laminated layer is formed as a continuous layer over the display region in this embodiment. However, the laminated layer may be patterned with respect to each pixel region, each row, or each column. The corresponding pixels are included in both the row and the column.

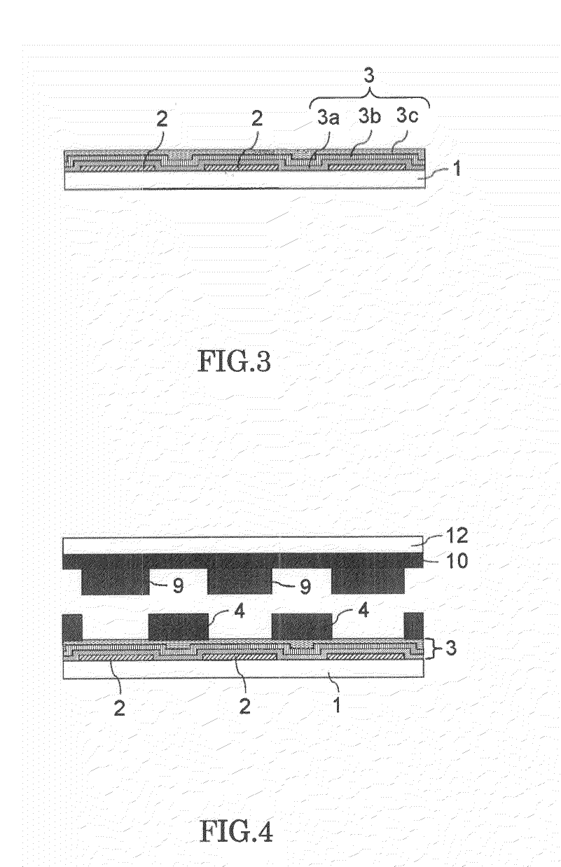

As shown in FIG. 3, the light emission layer 3c is formed on the hole transport layer 3b by well-known laser thermal transfer technique. The light emission layer 3c is transferred by following steps. First, a peeling layer, which is softened with local heating by laser irradiation, and transfer layer are arranged in an order on the transfer substrate. Next, photo irradiation or heating is performed onto a prescribed area in a state in which of the transfer layer and the transfer substrate are opposed each other so as to peel the transfer layer from the peeling layer. Further, the transfer layer corresponding to the prescribed area is transferred on the substrate formed.

In such a manner, the light emission function layer 3 constituted with the hole injection layer 3a, the hole transport layer 3b and the light emission layer 3c is formed.

The hole injection layer 3a acts as a layer in which holes are injected from the first electrode 2. Materials mentioned below can be used as the hole injection layer 3a, such as 3,4-polyethylenethiophene/polystyrenesulfonate (PEDOT/PSS), polystyrene, polypyrrole, polyaniline, polyacetylene, or derivatives of these materials or the like in polymer materials, for example, and copper phthalocyanine, m-MTDATA, TPD, α-NPD or the like in low molecular materials, for example.

The hole transport layer 3b acts as a layer in which holes are injected from a lower electrode 7 mentioned after. Materials mentioned below can be used as the hole transport layer 3b, such as PEDOT (poly(ethylenedioxy)thiophene), PSS (polystyrenesulfonate) or the like.

The light emission layer 3c includes an organic EL element emitting blue when emitted light is blue, for example, an organic EL element emitting green when emitted light is green, for example, and an organic EL element emitting red when emitted light is red, for example.

As specific materials, rubrene, platinum octaethylporphyrin, benzothienylpyridine-acetylacetone-iridium complex, polyethylene terephthalate, perinone, 9-(Diethylamino)-5H-benzo[α]phenoxazin-5-one, aluminoquinoline complex, bis(benzquinolinate) beryllium complex, quinacridone, coumalin, anthracene, diphenyltetrazene, 2-tert-butyl-9,10-di(naphthalen-2-yl), perylene, tetra-phenylanthracene, tetra-phenylbutadiene, 9,10-bis((phenylethynyl)anthracene, poly(para-phenylene vinylene),
poly(2-methoxy,5-(2′-ethylhexoxy)-1,4-phenylene vinylene),
poly(3-alkylalkylthiophene),
poly(9,9-dialkylfluorene), poly para-phenylene,
   polycarbonate, polynapthylvinylene and the like can be nominated. Further, a light emission material can be suitably selected corresponding to a desired emission color.

Each of the first electrodes is patterned corresponding to the row including the pixel areas in this embodiment. However, patterning may be carried out corresponding to each of the pixel area or the column including the pixel areas.

Successively, as shown in FIG. 4, a barrier layer 4 is formed on the light emission function layer 3 by laser thermal transfer technique, super ink jet coating or the like, for example. A photo thermal layer 10, in which light of the laser is converted to heat, and a barrier transfer layer 9 are laminated in an order in the laser thermal transfer technique. A prescribed area of a transfer substrate 12 is irradiated with light or heated in a state in which the barrier transfer layer 9 is opposite to the substrate 1 so as to peel the barrier transfer layer 9 from the photo thermal layer 10, so that the barrier transfer layer 9 corresponded to the prescribed area is transferred to the light emission function layer 3.

Further, a solution of a barrier layer material is formed on the prescribed area and dried in super inkjet coating.

The barrier layer 4 is formed to surround the first electrode 2, and is composed of photosensitive resin or non-photosensitive resin, for example, acrylic resin, polyimide resin or the like.

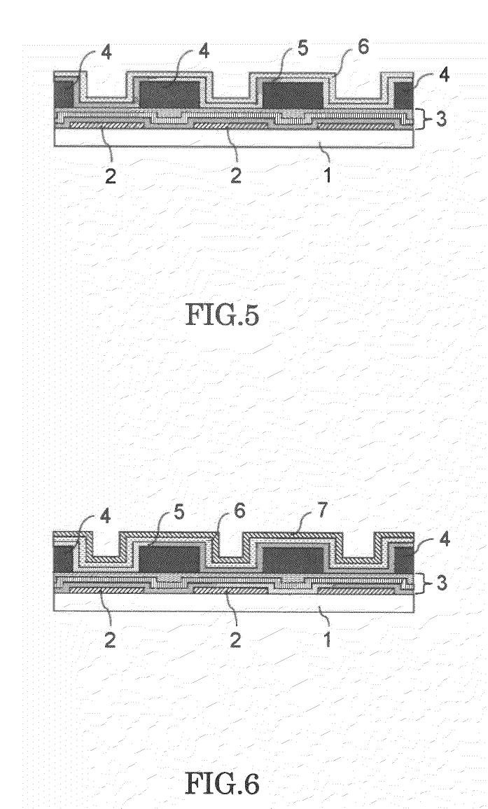

As shown in FIG. 5, an electron transport layer 5 and an electron injection layer 6 are laminated in an order to cover surfaces of the barrier layer 4 and the function layer 3 which is formed between the two barrier layers 4 by well-known vacuum evaporation. Further, the electron transport layer 5 and the electron injection layer 6 are laminated in the order to cover the surfaces of the barrier layer 4 and the function layer 3 in this embodiment, however, patterning may be carried out corresponding to each of the pixel area or the column including the pixel areas. In this case, a mask having the pattern is used and vacuum evaporation is performed.

The electron transport layer 5 in which electrons are transported is composed of quinolinol derivative, oxadiazole derivative, triazole derivative, fullerene derivative, phenanthroline derivative, quinoline derivative or the like, for example, can be used. Further, the electron transport layer 5 is formed to cover the barrier layer 4 in this embodiment. However, barrier layer 6 may be formed on the electron transport layer 5, and patterning may be carried out corresponding to each of the pixel area including the pixel areas or the column.

The electron injection layer 6, which is formed on the electron transport layer 5, is composed of a material including oxide, for example. Specifically, lithium fluoride, magnesium fluoride, calcium fluoride, strontium fluoride, barium fluoride, aluminum oxide or the like can be nominated.

As shown in FIG. 6, the second electrode 7 called a cathode is formed on the electron injection layer 6 by well-known evaporation.

The second electrode 7 composed of a material with smaller work function, such as lithium (Li), sodium (Na), potassium (K), rubidium (Rb), cesium (Cs), magnesium (Mg), calcium (Ca), strontium (Sr), barium (Ba) or the like, or an electrode including such as aluminum (Al), silver (Ag), gallium (Ga), vanadium (V), titanium (Ti), bismuth (Bi), tin (Sn), chromium (Cr), antimony (Sb), copper (Cu), cobalt (Co), gold (Au) or the like.

Next, an encapsulation substrate with a cap shape, for example is formed, successively, the encapsulation substrate is arranged on the substrate 1 with the structure mentioned above. The substrate and the encapsulation substrate is attached each other using a encapsulation member composed of UV hardening resin so as to be airproofed. The organic EL display device is formed by the process mentioned above.

The barrier layer 4 is formed after the light emission function layer 3 is arranged, so that the barrier transfer layer can be directly transferred to be faithfully formed as the pattern in nearly flatten state in this embodiment. Therefore, failure such as variability of a transfer width or a transfer defect can be decreased in the barrier layer, so that transfer accuracy can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

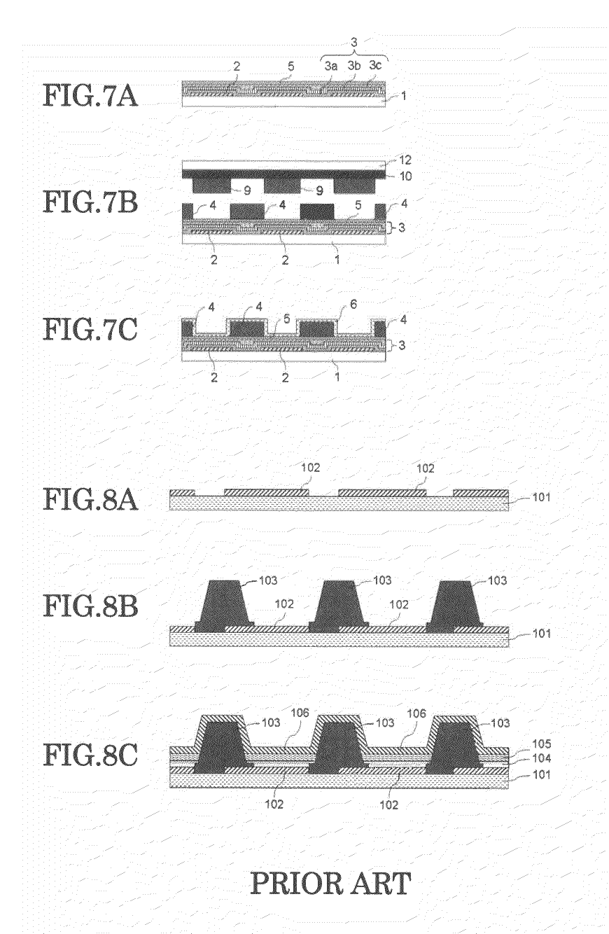

For example, the electron transport layer 5 is formed to cover the barrier layer 4 and the exposed light emission function layer 3 after the barrier layer 4 is formed in the embodiment. However, an order between forming electron transport layer 5 and forming the barrier layer 4 can be exchanged. In other words, first, the electron transport layer 5 is formed on the light emission function layer 3 as shown in FIG. 7A, after forming the light emission function layer 3 as shown in FIG. 3 in the embodiment. Next, the barrier layer 4 is formed as shown in FIG. 7B. Further, as shown in FIG. 7C, the electron injection layer 6 is formed to cover the barrier layer 4 and the exposed electron transport layer 5.

What is claimed is:

1. A method of fabricating an organic electroluminescence display device, comprising:
forming a plurality of first electrodes with a prescribed interval on a substrate;
forming a light emission function layer including a light emission layer on at least an upper surface of each of the first electrodes;
forming a barrier layer on a upper surface of the light emission function layer between the first electrodes after forming the light emission function layer;
forming a second electrode on the first electrode.

2. The method of claim 1, further comprising:
forming an electron injection layer between the barrier layer and the second electrode.

3. The method of claim 1, further comprising:
forming the electron injection layer, after forming the light emission function layer and before forming the barrier layer.
